(19) United States
(12) Patent Application Publication
(10) Pub. No.: US 2026/0175853 A1
(43) Pub. Date: Jun. 25, 2026

(54) Methods and Systems for Improving Automobile Safety

(71) Applicants: Asteris Ling, Redwood City, CA (US); Siriust Ling, Redwood City, CA (US)

(72) Inventors: Asteris Ling, Redwood City, CA (US); Siriust Ling, Redwood City, CA (US)

(21) Appl. No.: 18/988,974

(22) Filed: Dec. 20, 2024

(51) Int. Cl. B60W 50/12; B60W 10/18; B60W 10/20; B60W 30/14

(52) U.S. Cl. CPC B60W 50/12; B60W 10/18; B60W 10/20; B60W 30/146; B60W 2510/20; B60W 2520/10; B60W 2540/10; B60W 2540/12; B60W 2710/207; B60W 2720/10

(57) ABSTRACT

The accelerator of modern automobiles, especially electric vehicles, can be overly responsive, i.e., a small accelerator input can cause a relatively large increase in power applied to the drivetrain. This characteristic is beneficial for quick acceleration during medium to high-speed driving. However, it can be disadvantageous during low-speed maneuvers where space is tight and/or rolling resistance is high. To improve the safety and operating convenience, a special model can be added to the selections of automobile driving modes. This special mode can be activated automatically by the vehicle based on information such as vehicle location or manually by the driver.

### TECHNICAL FIELD

The disclosed embodiments relate generally to electronic circuits, including but not limited to methods, systems, and devices for providing the operator of an automobile or other land-based vehicles that are propelled by machines, e.g., internal combustion engine(s) and/or electric motors, with a limited speed driving mode that can improve and/or enhance the operational safety of the vehicle.

### BACKGROUND

The speed of an automobile is typically controlled by the operator through a combination of throttle, brake and transmission. Usually, the operator is human, but in the case of various levels of autonomous driving, the operator is essentially the center control unit of the automobile. One example is a steep driveway to a small parking spot. An automobile accelerator and speed control system can act in a special mode during such a low-speed maneuver. Instead of a small control input, i.e., accelerator position, generating a large control output, i.e., power being applied to the drivetrain, the control system determines the proper power being applied to the drivetrain and the proper speed to maintain. For advantages in safety and convenience, more and more automated speed control mechanisms are becoming available. These include adaptive cruise control and hill descent control, which usually work at relatively higher speeds or on downhill driving paths respectively. The common characteristics of these automated speed controls are maintaining a preset constant speed. The limits on these controls include that the preset speed needs to be above a minimum value and/or only works for off road conditions. One common case that requires precise low speed maneuver is a paved steep driveway (often found in hilly residential areas) with a relatively short distance leading to the building. In this case, the vehicle needs to maintain sufficient speed to climb the drive way yet needs to stop in a very short distance. Another case, which can be combined with the first one, is a parking spot with very limited space where the vehicle needs to move at very low but varying speed. The existing speed control modes like adaptive cruise control and hill descent control do not provide the relief on the required human effort as they either work only above certain minimum speed or under offroad conditions or for maintaining a constant (non-varying) speed.

A limited speed driving mode that can also be called “idle” or “slow” mode where the vehicle speed is still proportional to the accelerator input but maintains a user selectable top speed, e.g., 3 mph regardless of the accelerator input. In this mode, the vehicle can be maneuvered in tight space and/or near the obstacles with reduced danger of unintentional sudden motion without the intervention of the emergency braking system.

The same driving mode in which the user can choose to let the vehicle maintain a constant speed, e.g., 3 mph regardless of the accelerator input. In this mode, the vehicle will be able to move safely on a large incline without the danger of the user over or under compensating the accelerator causing unintended motions.

The usage of the limiting speed mode is not limited for low-speed maneuvering. It can be also applied to limit the power and acceleration of the automobile to prevent both unnecessary speed and fuel/energy consumption.

### SUMMARY

This application is direct to systems, devices and methods that include one or multiple drive modes of a vehicle. To improve the safety and convenience of the operation of automobiles, one or more low speed and operator selectable modes can be added to the automobile. In these modes, the operator can choose to let the automobile to automatically maintain a speed preselect by the operator or to let the automobile to automatically select a throttle setting such that the speed is still monotonically increasing with respect to the throttle applied but the maximum speed allowed is a preset value chosen by the operator. This mode is applicable to both forward and reverse driving. Variable steering ratio that may or may not already exist in the automobile can be (added and) combined with such a low-speed control mode.

### BRIEF DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A Illustrates a typical setup of speed control in an automobile. In the case of human operators, the driver 100 looks at the speedometer 101 and decides to push the throttle 102 or brake 103 to increase or reduce the speed.

FIG. 1B Demonstrates a closed-loop feedback control with human eyes as the sensing component and the foot on throttle or brake pedal as the actuating component. Another possible setup that is also outlined here is an electro-mechanical operator where the human operator 100 would be replaced by a processing unit 110 with electronic and/or mechanical components, including but not limited to system outputs 111 and sensor inputs 112, that can sense the current speed and increase or reduce or maintain it through the throttle and/or brake.

FIG. 2A Illustrates several possible drive mode selections as a rotary dial 200 in an automobile. It is to be noted that the illustrated rotary dial can be physical or virtual, e.g., dials on touch screens.

FIG. 2B Shows a set of buttons 210 or a rocker switch 220 as drive mode selectors. It is to be noted that the illustrated buttons can be physical or virtual, e.g., buttons on touch screens.

FIG. 3A Illustrates an example case where it is beneficial that sensitivity of speed with respect to the throttle input is low. A steep uphill driveway 300 is shown leading to a short parking spot 301 at the top of the driveway.

FIG. 3B Shows another example where it is beneficial that sensitivity of speed with respect to the throttle input is low. A parking spot 302 is illustrated where surrounding obstacles severely limit the parking and potential maneuvering space.

FIG. 4A Illustrates a possible added limited speed drive mode 400 in an automobile as part of a rotary dial that can be used to set the maximum or constant speed of the vehicle depending on the specific mode. It is to be noted that the illustrated rotary dial can be physical or virtual, e.g., dials on touch screens.

FIG. 4B Shows a potential limited speed drive mode 400 in an automobile as part of a set of buttons 210 or a rocker switch 220.

FIG. 5 illustrates example block diagrams of how the limited speed mode shares components with other drive modes 500 of the automobile. Vehicle sensors take dynamic information 501 such as speed, direction, and acceleration etc. and information about the surrounding environment derived from location information 502 provided by GPS or other positioning systems.

FIG. 6 illustrates an example block diagram of the speed control system in the limited speed mode. Sensors 112 gather and provide the processing unit 110 with information about the dynamic states 501 and location information 502 of the vehicle. As described above, the dynamic states may include speed, acceleration and direction, states of control of the vehicle, such as steering, throttle and brake input. Information about the surrounding environment of the vehicle can be derived from the location information, which is provided by the GPS or other positioning systems. The processing unit generates optimal decisions based on all available information. These optimal decisions optimize the vehicle motions such as speed, direction and acceleration by adjusting the vehicle driving mechanism, such as limiting the power and/or speed 600, applying the optimal throttle response 601, applying the optimal steering ratios 602 and/or varying the range of steering angles 603. Furthermore, this process is a closed-loop system, any current measurement of the vehicle states, i.e., the system output 111 serves as part of the sensor input 112 to the processing unit.

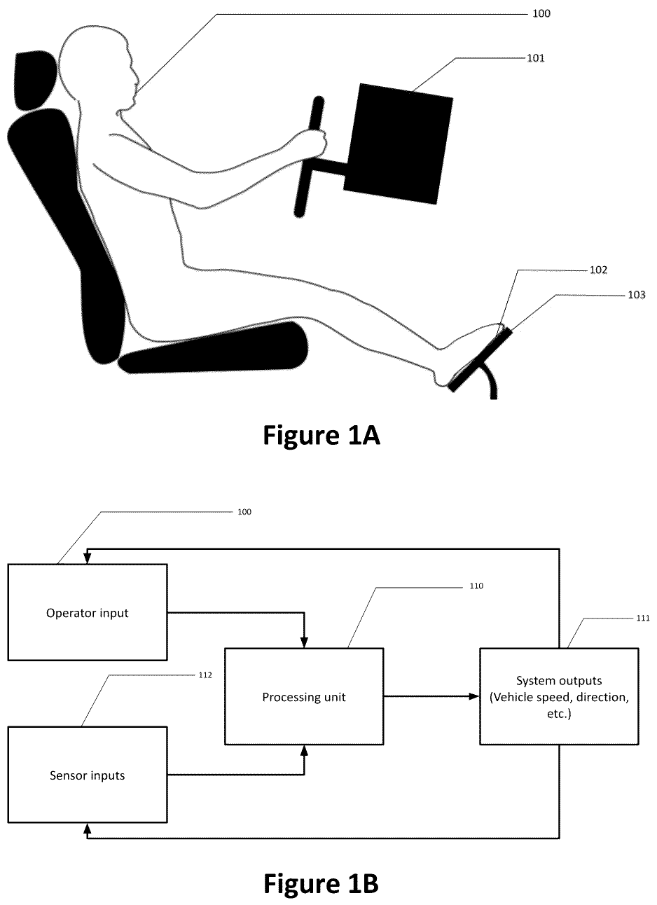

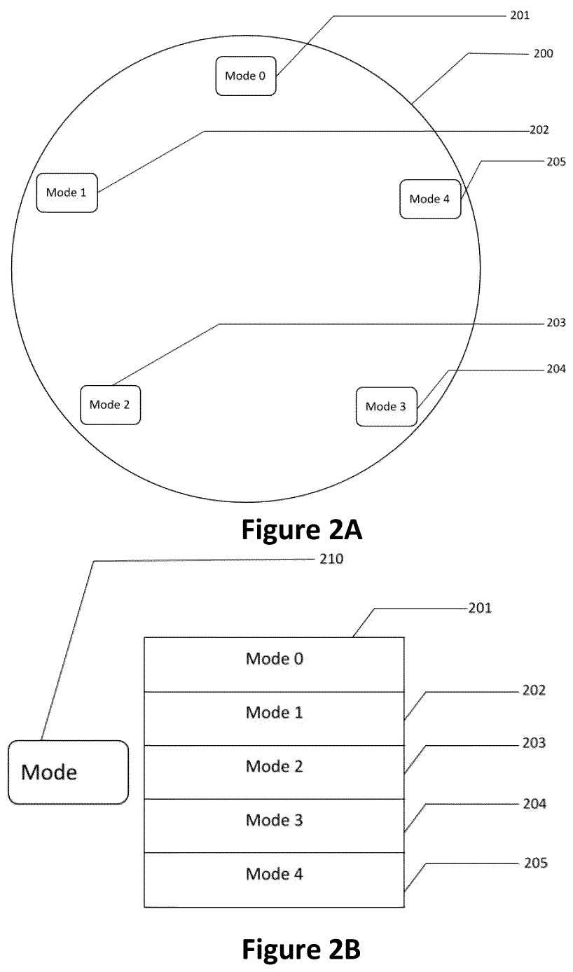

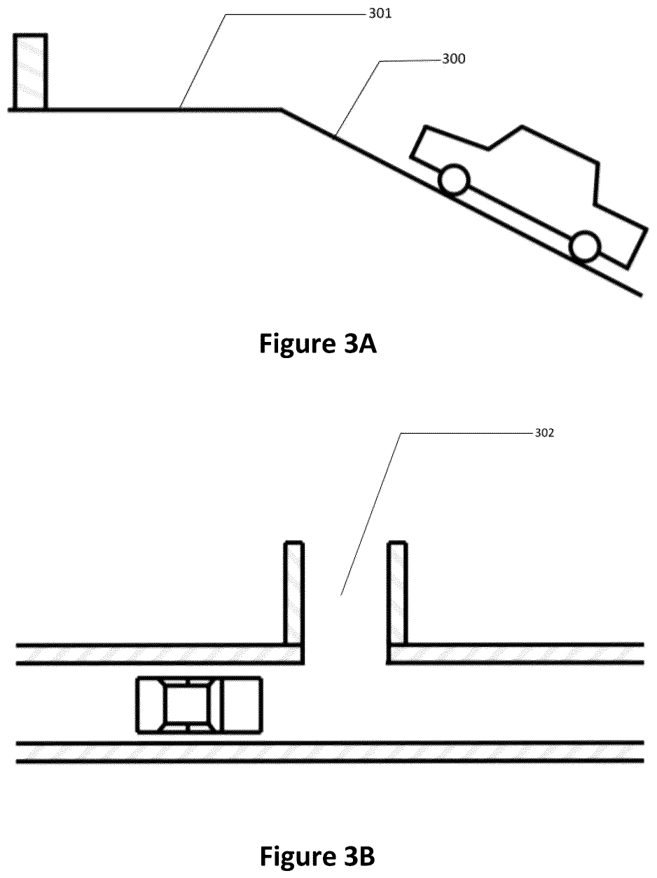

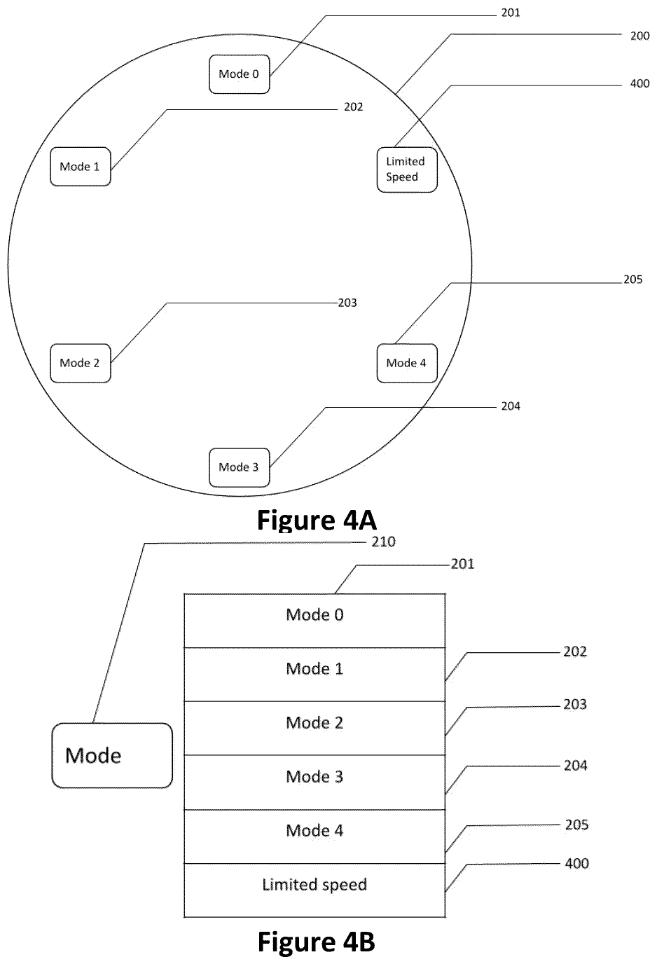

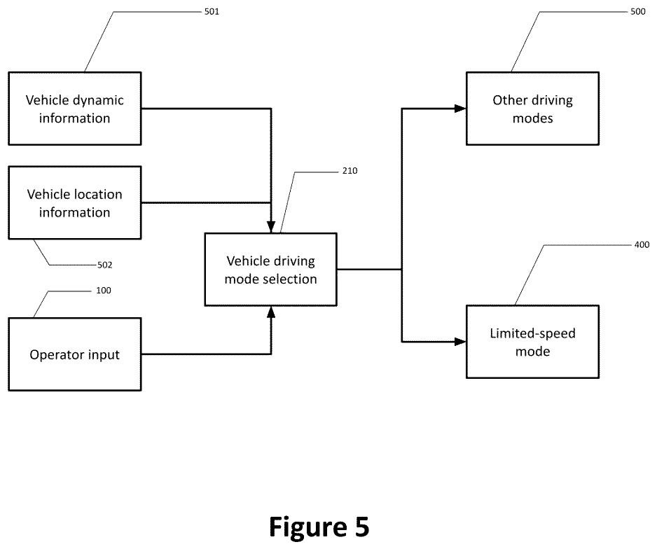

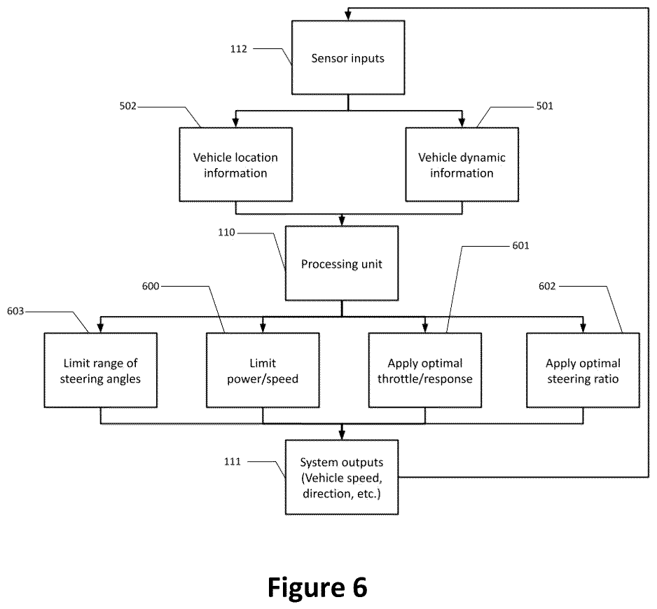

What is claimed is:

1. A system of automobile speed control, comprising:
a processing device that can make decisions or suggestions to the operator based on a plurality of inputs; an operator selection device, set by the operator or suggested by the central processing device and accepted by the operator, to enter into a dedicated low speed operating mode; and a set of sensors that can take measurement of the surrounding environment, may include but not limit to steering angle, throttle and brake positions, orientation and speed of the automobile, inclination, width and length of the surrounding pathways; and a set of control mechanisms, may include but not limited to engine and/or electrical motor throttle and brakes and gear ratios; and while in the said dedicated low speed operating mode, the processing device is configured to control or assist controlling the direction and speed of the automobile base on a model so it can progress as the operator intends to without hitting the obstacles around it; and while in the said dedicated low speed operating mode, the processing device is configured to allow the operator to take over the speed control by overriding the low-speed operating mode.

2. The method of claim 1, further comprising:
from sensors and the operator, obtaining a plurality of inputs, which may include but not limit to velocity, steering angle, throttle and brake positions, distances to the surrounding objects; and based on the settings of the limiting speed control mode in claim 1, maintaining the speed of the automobile to a constant value set by the operator or determined by the processing device that it deemed optimal for the maneuver intended by the operator; or based on the settings of the limited speed control mode in claim 1, mapping the throttle response of the automobile to a range of speed between no motion (zero speed) to a speed that is either set by the operator or determined by the processing device that it deems optimal for the maneuver intended by the operator, and/or mapping the steering ratios of the automobile to a range of steering angles either set by the operator or determined by the processing device that it deems optimal for the maneuver intended by the operator;

3. The method of claim 1, further comprising:
a learning mode, wherein the operator controls the speed and the processing device keeps obtaining a plurality of inputs, which may include but not limit to velocity, steering angle, throttle and brake positions, distances to the surrounding objects and location information of the vehicle;
and the processing device can use all or part of the information collected to build and/or update the model used for controlling or assisting controlling the direction and speed of the automobile.
